(19) United States
(12) Patent Application Publication
(10) Pub. No.: US 2003/0133228 A1
(43) Pub. Date: Jul. 17, 2003

(54) Microactuator for a disc drive suspension

(76) Inventors: Shixin Chen, Singapore (SG); Yi Lu, Singapore (SG); Jianqiang Mou, Singapore (SG)

Correspondence Address: Charles Berman, Esq., GREENBERG TRAURIG, LLP, Suite 400 E, 2450 Colorado Avenue, Santa Monica, CA, 90404, US

(21) Appl. No.: 10/229,296

(22) Filed: Aug. 14, 2002

(30) Foreign Application Priority Data
Jan. 11, 2002 (SG) 200200161-8

(51) Int. Cl. G11B 5/127

(52) U.S. Cl. 360/244.3

(57) ABSTRACT

An electrostatic microactuator for a slider in a disc drive is characterised in that it is formed from a single crystal silicon wafer. This provides a microactuator that has very low parasitic capacitance, virtually no mechanical or thermal creep, or mismatch problems as may occur when parts are separately fabricated. It also allows for efficient mass production by allowing for many of the microactuators to be simultaneously formed from the single crystal silicon wafer. The microactuator comprises a first (stationary) part (22) for attachment to a flexure of a head positioning system in a disc drive and a second (movable) part (24) to which a slider is attachable, which is pivotally coupled (42, 44) to the first part. The first and second parts include elongate strips (30, 32) which are interdigitated to provide comb electrodes.

### TECHNICAL FIELD

The present invention relates to a microactuator for a slider in a disc drive head positioning system. The invention also relates to a microactuator and slider assembly. In particular the microactuator is an electrostatically operable microactuator.

### BACKGROUND

The radial positioning of data tracks on magnetic discs is continually being decreased so as to increase the data storage capacity of such discs. This has led to the development of microactuators which allow precision positioning of the read/write transducer head of a slider over a track after the head has been coarsely positioned by, for example, a known voice coil motor which operates an actuator suspension arm. The slider is commonly mounted on a flexure (also termed a gimbal) usually at the end of such a suspension arm.

A microactuator must be capable of quickly and accurately positioning the read/write head of a slider. The microactuator should also be light weight to minimise detrimental effects on the resonance characteristics of the suspension arm, and relatively thin to enable close disc-to-disc spacing. To be commercially viable the microactuator must also be reliable and capable of being efficiently manufactured. Such viability generally requires mass production fabrication techniques, which must be such as to ensure the dimensional accuracy of the microactuators measured in microns. It is also necessary that the microactuators retain their dimensional and thus high resolution positioning accuracy possibly over a wide temperature range, as may be necessary in for example a hard disc drive (HDD) system.

Known electrostatic microactuators have been fabricated from polysilicon or nickel based metals. However micro structures fabricated using these materials have problems in large scale (mass) manufacturing. These problems include dimensional non-uniformity, residual stresses in the materials, thermal expansion of the material leading to mismatches between parts and poor reproducibility. Thus there is a need to provide a microactuator structure, particularly for an electrostatic microactuator, which is suitable for mass production such as will reduce the above mentioned problems.

Electrostatic microactuators are known, see for example, U.S. Pat. No. 5,995,334 in the name of Long-Sheng Fan et al. Although high volume production is a matter which this prior patent addresses, the solution which is offered relates to replacement of conventional wiring to a microactuator with microfabricated wiring, which is formed using lithographic techniques and stencil plating. This patent does not relate to a microactuator which is able to be mass produced as in the present invention, as disclosed herein below.

U.S. Pat. No. 5,898,541 in the name of Z-E Boutaghou et al relates to a microactuator fabricated at the wafer level by conventional thin film techniques used to manufacture the transducing head on the slider. However this microactuator is a piezoelectric and not an electrostatic microactuator.

### DISCLOSURE OF THE INVENTION

An object of the present invention is to provide an electrostatic microactuator having good dimensional accuracy and stability and which can be mass manufactured at the wafer level.

Accordingly, the present invention provides a microactuator for a slider in a disc drive, the microactuator comprising

a first part for attachment to a flexure of a head positioning system in a disc drive,

a second part to which a slider is attachable,

the first and second parts being coupled together such that they are relatively movable and each part including portions which form electrodes for providing electrostatic forces for moving the second part relative to the first part,

wherein the first and second parts are formed from a single crystal silicon wafer.

The first part may be termed the stationary part because in use it remains stationary relative to the flexure, and the second part may be termed the movable part because in use it moves relative to the stationary part.

Manufacturing the microactuator from a single crystal silicon wafer provides a microactuator that has very low parasitic capacitance, virtually no mechanical or thermal creep, or mismatch problems as may occur between the stationary and movable parts of a microactuator when those parts are separately fabricated. At the same time, it allows for efficient mass production by forming many such microactuators from the single crystal silicon wafer.

Thus the electrostatic microactuator may be formed by etching into the top surface of a single crystal silicon wafer. Developed epi-micromachining technique is used to make the microactuator in the single crystal silicon wafer as described in more detail hereinbelow.

Preferably the first (i.e. stationary) part of the microactuator includes several small pads formed on a surface thereof via which the microactuator can be bonded to the flexure of the head positioning system. Such pads may be formed by epi-micromachining. Alternatively, several pads may be formed on the flexure for the same purpose. A bonding technique such as flip chip or fusion bonding can be used to fix the microactuator onto the flexure of the suspension via such pads.

Preferably the second or movable part of the microactuator includes a slot formed in a surface thereof (for example, its bottom surface) which is opposite a surface thereof (for example, its top surface) in which the first stationary part of the microactuator is formed. This slot provides for a slider to be attached to the second or movable part of the microactuator, for example, by bonding the slider into the slot. The slot may be formed by etching during manufacture at the wafer stage. Thus the invention also provides an assembly of a microactuator and a slider.

Preferably the portions of the first and second parts which form the electrodes for providing electrostatic forces, are interdigitated elongate portions or strips of, alternately, the first and second parts. Adjacent ones of these elongate portions may include lateral extensions providing comb electrodes, thereby providing a capacitative comb drive electrode arrangement. These elongate portions or strips may extend radially of the coupling between the first and second parts, or linearly therefrom in an orthogonal direction, in which case the first (stationary) part of the microactuator may have a main body of “Greek cross” shape in plan view. Other shapes for the first part of the microactuator are possible provided that its body and its elongate electrode portions or strips can be fabricated from a single crystal silicon wafer using etching techniques. The interdigitated portions in effect provide capacitative electrodes.

Preferably a means in the form of a cap or a dust cover is provided for protecting a microactuator of the invention from particulate contamination. Such a cap or dust cover is separately fabricated and will contain several holes through which the hereinbefore described bonding pads may extend.

For a better understanding of the invention and to show how the same may be carried into effect, preferred embodiments thereof will now be described, by way of non-limiting example only, with reference to the accompanying drawings.

### BRIEF DESCRIPTION OF DRAWINGS

FIG. 1 shows an actuator suspension arm over a disc.

FIG. 2 is an underneath perspective view of the end of the actuator suspension arm of FIG. 1 on which is mounted a microactuator and slider assembly according to an embodiment of the invention.

FIG. 3 is a top perspective view of the microactuator and slider assembly of FIG. 2.

FIG. 4 is an underneath perspective view of the microactuator from the assembly of FIG. 3.

FIG. 5 is a similar view to that of FIG. 2 but with the microactuator and slider assembly omitted.

FIG. 6 is a top perspective view of another embodiment of a microactuator and slider assembly according to an embodiment of the invention and which includes a dust cover.

FIGS. 7, 8 and 9 are top plan views of various designs of microactuators according to embodiments of the invention.

FIG. 10 shows a silicon wafer in which an array of microactuators have been formed.

### DETAILED DESCRIPTION OF PREFERRED EMBODIMENTS

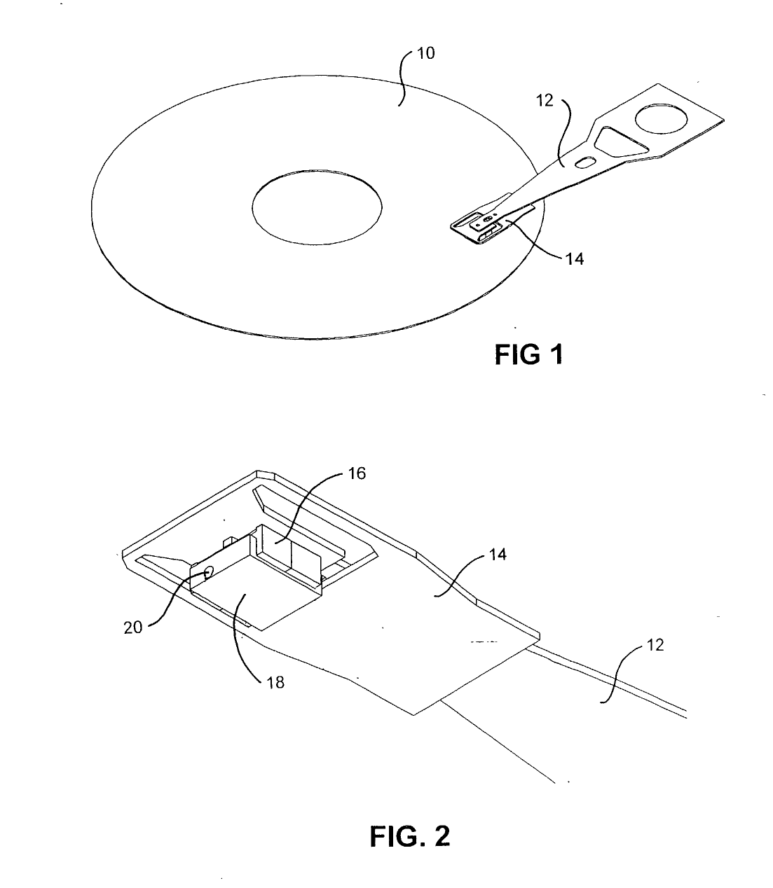

With reference to FIGS. 1 and 2, a dual stage actuation system for positioning a head over a disc 10 of a hard disc drive includes a suspension arm 12 which is coarsely positionable over the disc 10 by a motor (not shown) such as a voice coil motor. The suspension arm 12 supports a flexure 14 on which is attached an electrostatic microactuator 16 and slider 18 assembly. The slider 18 includes read/write head elements 20 and the microactuator 16 is actuable to finally move the slider 18 such that the read/write head elements 20 can be located with precision over a magnetic track on the disc 10. Thus the first stage of the dual stage actuation system comprises the motor driven suspension arm 12 and the second stage comprises the fine adjustment achieved via the microactuator 16.

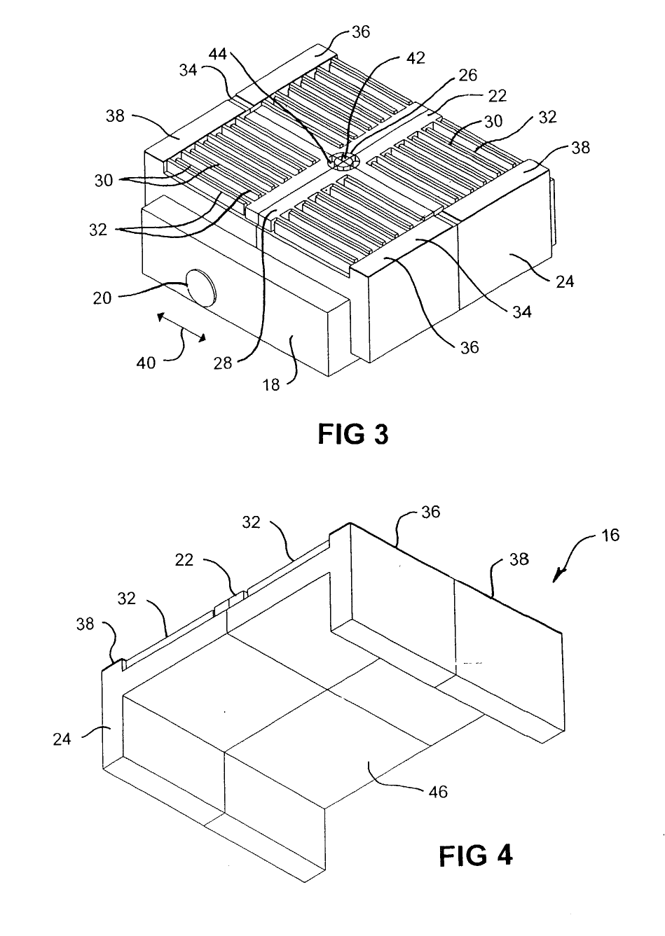

The microactuator 16 (see FIGS. 3 and 4) comprises a first or stationary part 22 for attachment to the flexure 14 and a second or movable part 24 to which the slider 18 is attachable. The first and second parts 22, 24 are coupled together at a coupling 26 such that the second part 24 is movable relative to the first part 22. Stationary part 22 has a body 28 of a “Greek cross” shape in plan view from which extend elongate portions 30 (in the nature of fingers) which are formed to provide comb electrodes. Movable part 24 is also formed to have elongate portions 32 which extend inwardly from opposite edges 34 thereof and which are also formed to provide comb electrodes. The elongate portions 30 of stationary part 22 are interdigitated with the elongate portions 32 of movable part 24 and the comb electrodes of the elongate portions 30 and 32 are also interdigitated such that a capacitative comb-drive electrode arrangement is provided.

Two pairs of electric connection pads 36, 38 are formed on the opposite edges 34 of movable part 24 and are connected with the electrodes of the moveable part 24, namely the elongate portions 32 (as described hereinbelow). The electrical connections are such that when a voltage is applied between the electrodes of the stationary part 22 and one pair of the connection pads, for example 36, electrostatic forces of attraction are generated between the respective comb electrodes of elongate portions 30 and 32 which cause the movable part 24 to rotate about coupling 26 relative to the stationary part 22 either to the left or right as indicated by arrow 40. Connection of the voltage to the other pair of connection pads, for example 38, will cause movement of movable part 24 in the opposite direction.

A differential driven scheme can be used to drive the read/write head elements 20 to linearize the voltage/force relationship. These features are advantageous for high performance servo control, since they make the microactuator 16 voltage/displacement relationship linear.

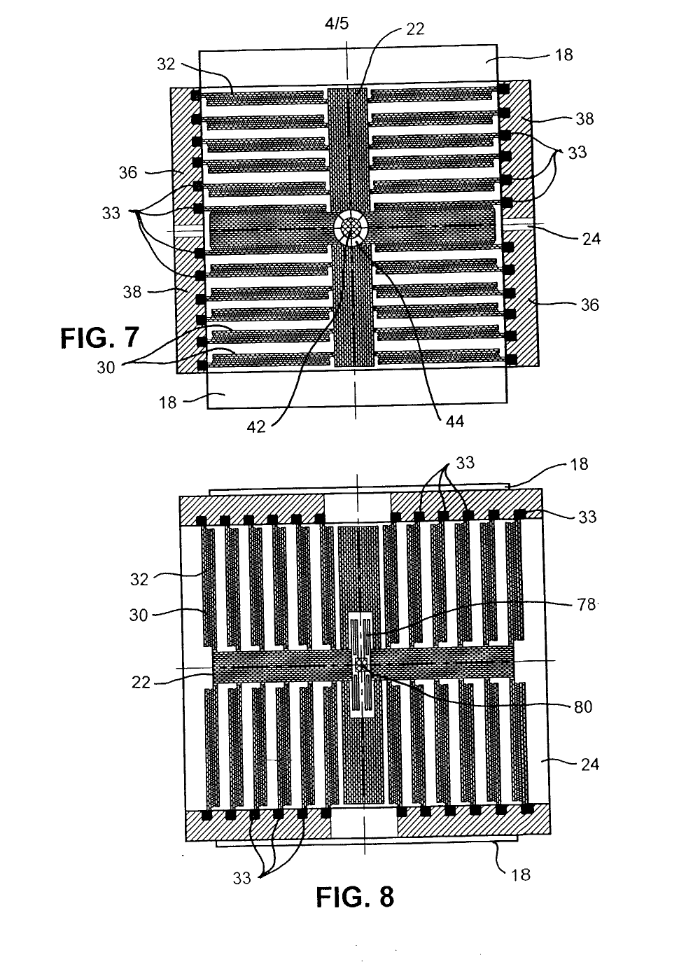

The coupling 26 is formed by a post 42 of the movable part 24 extending into a central aperture in the body 28 of stationary part 22 and a flexure beam 44 which extends between the post 42 and the surrounding surface of the aperture. The flexure beam 44 effectively holds stationary part 22 in suspension relative to movable part 24. The post 42 and flexure beam 44 are formed by deep reactive ion etching (RIE), however because this coupling 26 both structurally and therefore electrically interconnects the first (stationary) and second (moveable) parts 22 and 24 of the microactuator 16 (because post 42 upstands from the body of moveable part 24), it is necessary that the elongate portions 32 of the moveable part 24 be electrically isolated from the remaining body structure of moveable part 24 such that these portions 32 and the elongate portions 30 of the stationary part 22 are electrically isolated. This is achieved by an electrically insulating structural interconnection of the elongate portions 32 of moveable part 24 to the opposite edges 34 of moveable part 24 at anchor locations referenced 33, see FIGS. 7, 8 and 9. This structural interconnection, that is the anchors 33 are formed during fabrication of the microactuator 16 from a single crystal wafer of silicon material by filling etched spaces between elongate portions 32 and edges 34 (that is, at locations 33) with say silicon dioxide. Electrical interconnection is then made between the elongate portions 32 and the electric connection pads 36, 38 (which pads are formed over an electrically insulating oxide layer on edges 34 of moveable part 24 so that they are isolated from the moveable part 24) by metallisation over the anchors 33. A slot 46 is formed in the lower surface of the movable part 24 (see FIG. 4) for the slider 18 to be attached to the microactuator 16. Slider 18 is seated in slot 46 and bonded to the silicon material of the microactuator for attachment thereto.

The microactuator 16 is characterised by the first or stationary part 22 and the second or moving part 24 being formed from a single crystal silicon wafer. Thus an array of the microactuators 16 are simultaneously fabricated from a single crystal silicon wafer 50 (see FIG. 10).

The starting wafer 50 is highly N-doped for electrical conductivity and slots 46 for attachment of sliders 18 are first etched into its back surface. The microactuators 16 are then fabricated into the top surface of wafer 50 using a developed epi-micromachining technique which is known. A masking oxide layer is deposited on the top surface of wafer 50 and the structures 26, 28 and 30 of stationary parts 22, and structures 32 of moveable parts 24, are formed into the top surface of the wafer 50 by deep reactive ion etching (RIE) and dry plasma release process to etch away selected (non masked) parts and retain the masked parts. The structures 32 are completely undercut at the bottom and on three sides leaving one end of each still connected to the wafer substrate. The resulting trench gaps are thermally oxidised and filled with low pressure chemical vapour deposition LPCVD silicon dioxide—which provides the anchors 33. The remaining connected ends of structures 30 and unwanted silicon dioxide are then removed by masking and etching, as is known. Thus, effectively, the first parts 22 of the microactuators 16 are formed within wafer substrate 50 and are “suspended” therein via the flexure beam 44 connections to the posts 42 (which posts are connected to the wafer substrate), and the elongate portions 32 are attached to the wafer substrate 50 at the silicon dioxide anchors 33. Appropriate oxidation and metallisation layers are then formed to provide the electric connection pads 36, 38 and connection to elongate structures 32 and the silicon wafer 50 with many of the just described microactuator structures formed in the top surface thereof and having slots 46 formed in the rear surface is sliced into blocks to yield arrays of the microactuator structures 16 which may then be individualised, whereby the resultant moveable part 24 of each microactuator 16 is constituted by what was a portion of the wafer substrate. Finally a slider 6 is inserted into the slot 46 of each microactuator to form a microactuator-slider assembly.

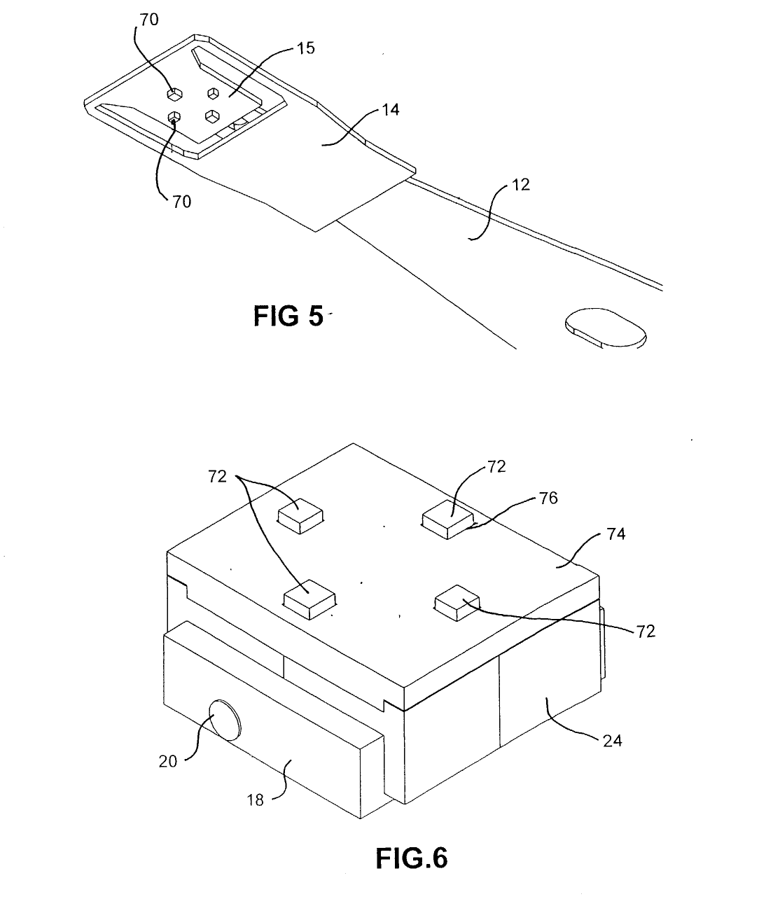

With reference to FIG. 5, in one embodiment, four small pads 70 are micro-machined from the undersurface 15 of flexure 14 for mounting of the stationary part 22 of the microactuator 16 thereon. The location of the pads 70 can be adjusted according to the flying requirements of the slider 18. Alternatively small pads 72 (see FIG. 6) can be fabricated on the stationary part 22 (which in FIG. 6 is hidden by a dust cover 74) for the same purpose.

Since small particles could possibly be trapped in the gaps between the electrodes of the stationary and moving parts 22, 24, of the microactuator and cause an electrical short circuit, a “dust cover” plate 74 is added over all the electrodes (see FIG. 6). The small pads 72 (or 70) can go through holes in the “dust cover” 74 for the stationary part 22 to be attached to the flexure 14 of suspension arm 12. A flexible material 76 can be used to seal the gap between the small pads 72 (or 70) and the holes in the “dust cover” 74.

FIG. 7 is a plan view of a microactuator 16 and slider 18 similar to that of FIG. 3. In this structure there are a number of the flexure beams 44 arranged radially.

FIG. 8 shows an alternative embodiment in plan view which differs mainly in the orientation of the electrode portions 30 and 32 and mainly in the coupling between the movable and stationary parts (the same reference numerals have been used for features and components which correspond to those of the previous figures). In this embodiment four flexure springs 78 extend from a central post 80 of the moveable part 24 and are attached to the body of stationary part 22. The flexure springs 78 are arranged symmetrically for translational motion of the moving part 24, and thus slider 18, relative to stationary part 22.

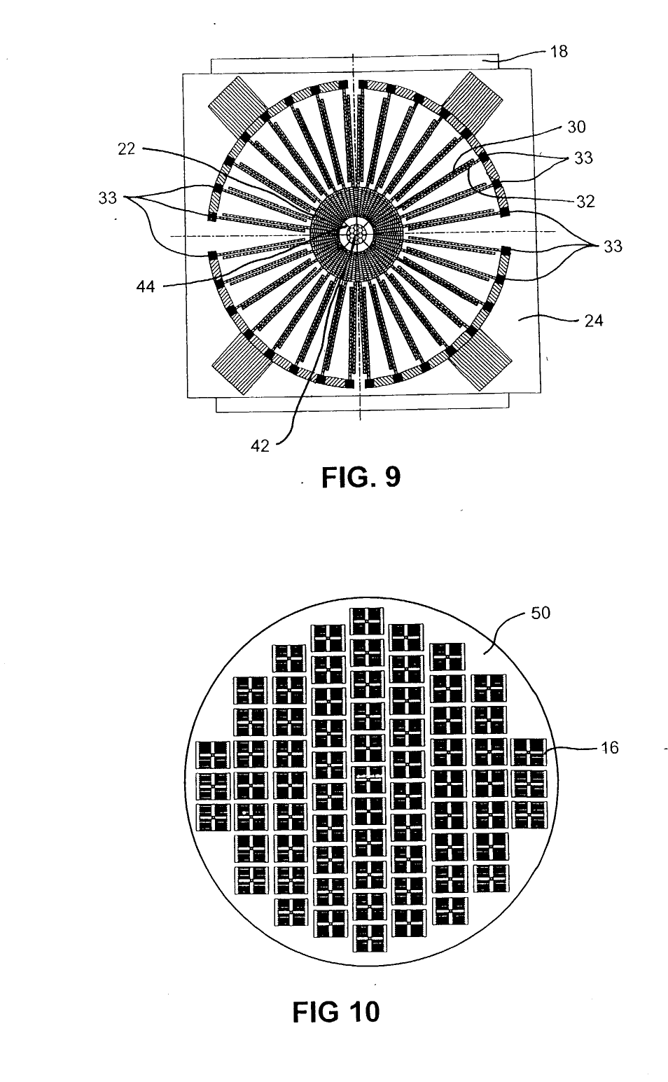

FIG. 9 shows a further embodiment in plan view in which the elongate portions 30 and 32 of respectively stationary part 22 and moving part 24 extend radially and define a parallel plate capacitative configuration (in contrast to a comb-drive arrangement as in FIGS. 7 and 8) to generate rotational motion of the moving part 24, and thus of slider 18, relative to stationary part 22.

Different displacements of the moveable part 24 relative to the stationary part 22 (depending on “spring” characteristics of coupling 26) and dynamic performance (that is, resonant frequency response) can be achieved with different design configurations of the microactuator 16.

The invention described herein is susceptible to variations, modifications and/or additions other than those specifically described and it is to be understood that the invention includes all such variations, modifications and/or additions which fall within the scope of the following claims,

1. A microactuator for a slider in a disc drive, the microactuator comprising
a first part for attachment to a flexure of a head positioning system in a disc drive,
a second part to which a slider is attachable,
the first and second parts coupled together such that they are relatively movable and each part including portions which form electrodes for providing electrostatic forces for moving the second part relative to the first part,
wherein the first and second parts are formed from a single crystal silicon wafer.

2. A microactuator according to claim 1 wherein the first part of the microactuator includes several small pads formed on a surface thereof for attaching the microactuator to a flexure of a head positioning system in a disc drive.

3. A microactuator according to claim 1 or 2 wherein the second part includes a slot formed in a surface thereof for a slider to be attached to the second part of the microactuator.

4. A microactuator according to any one claims 1 to 3 wherein the first part includes a body having a cross shape in plan view and wherein said portions which form electrodes are spaced elongate strips which extend outwardly from the arms of the cross, wherein the strips include lateral extensions providing comb electrodes.

5. A microactuator according to claim 4 wherein the portions of the second part on which are formed electrodes are spaced elongate strips which extend inwardly from opposite outer edges of the second part and which are interdigitated with the outwardly extending elongate strips of the first part, these strips also including lateral extensions providing comb electrodes which are interdigitated with the comb electrodes of the first mentioned strips.

6. A microactuator according to any one of claims 1 to 5 wherein the coupling together of the first and second parts is a pivot-like coupling such that the movement of the second part relative to the first part is a rotational movement.

7. A microactuator according to any one of claims 1 to 5 wherein the coupling together of the first and second parts is via flexure springs whereby the movement of the second part relative to the first part is a linear movement.

8. A microactuator according to any one of claims 1 to 3 wherein the first part includes a body of circular shape in plan view and wherein said portions which form the electrodes are elongate strips which extend radially outwardly.

9. A microactuator according to claim 8 wherein the portions of the second part which form the electrodes are elongate strips which extend radially inwardly such that they are aligned substantially parallel with the elongate strips of the first part.

10. A microactuator according to any one of the preceding claims including a cover located over the interdigitated portions of the first and second parts to prevent particles entering between the electrodes.

11. An assembly including a microactuator according to any one of the preceding claims and a slider, wherein the slider is bonded to the microactuator.

12. An assembly according to claim 11 wherein the second part includes a slot within which the slider is bonded, the slot being formed in a surface of the second part which is opposite a surface thereof in which the first part of the microactuator is formed.
